(19) United States
(12) Patent Application Publication
(10) Pub. No.: US 2017/0277393 A1
(43) Pub. Date: Sep. 28, 2017

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventors: Hideharu IWASHITA, Kanagawa (JP); Nozomi NOGUCHI, Kanagawa (JP); Ayaka ISHIHARA, Kanagawa (JP); Shinichi NAKAMURA, Kanagawa (JP)

(73) Assignee: FUJI XEROX CO., LTD., Tokyo (JP)

(21) Appl. No.: 15/218,462

(22) Filed: Jul. 25, 2016

(30) Foreign Application Priority Data
Mar. 22, 2016 (JP) 2016-056860

(51) Int. Cl. G06F 3/0481; G06F 3/0482

(52) U.S. Cl. CPC G06F 3/04817; G06F 3/0482

(57) ABSTRACT

An information processing apparatus includes a setting-information changing unit and a selecting unit. The setting-information changing unit changes setting information which is information for specifying a condition when a function is to be implemented. When a derived function obtained by changing the setting information of the function is to be stored in association with a selected icon, the selecting unit restricts selection of a first icon associated with the function, and permits selection of a second icon different from the first icon.

### CROSS-REFERENCE TO RELATED APPLICATIONS

This application is based on and claims priority under 35 USC 119 from Japanese Patent Application No. 2016-056860 filed Mar. 22, 2016.

### BACKGROUND

Technical Field

The present invention relates to an information processing apparatus, an information processing method, and a non-transitory computer readable medium.

### SUMMARY

According to an aspect of the invention, there is provided an information processing apparatus including a setting-information changing unit and a selecting unit. The setting-information changing unit changes setting information which is information for specifying a condition when a function is to be implemented. When a derived function obtained by changing the setting information of the function is to be stored in association with a selected icon, the selecting unit restricts selection of a first icon associated with the function, and permits selection of a second icon different from the first icon.

### BRIEF DESCRIPTION OF THE DRAWINGS

Exemplary embodiments of the present invention will be described in detail based on the following figures, wherein:

FIG. 1 is a diagram illustrating the hardware configuration of an image forming apparatus;

FIG. 2 is a block diagram illustrating the functional configuration of the image forming apparatus;

FIG. 3 is a diagram illustrating an exemplary initial screen;

FIG. 4 is a diagram illustrating an exemplary copy setting screen;

FIG. 5 is a diagram illustrating an exemplary screen for registering a derived function;

FIG. 6 is a diagram illustrating an exemplary screen for registering a derived function;

FIG. 7 is a diagram illustrating an exemplary transition in the initial screen;

FIGS. 8A and 8B are diagrams illustrating exemplary display forms of the icon of a derived function;

FIG. 9 is a diagram illustrating an exemplary display form of the icon of a derived function;

FIG. 10 is a diagram illustrating an exemplary display form of the icon of a derived function;

FIG. 11 is a diagram illustrating an exemplary display form of the icon of a derived function;

FIG. 12 is a diagram illustrating an exemplary display form of the icon of a derived function;

FIG. 13 is a diagram illustrating an exemplary display form of the icon of a derived function in the initial screen; and

FIG. 14 is a diagram illustrating an exemplary display form of the icon of a derived function in the initial screen.

### DETAILED DESCRIPTION

An exemplary embodiment of the present invention will be described.

### Configuration

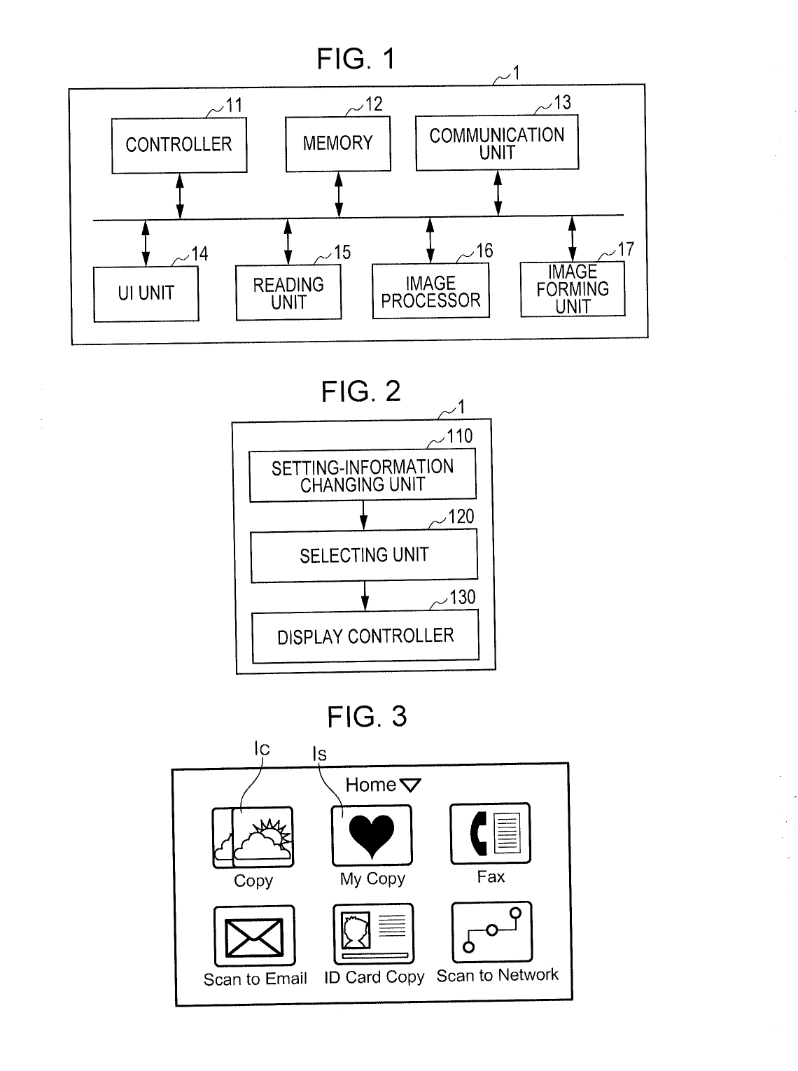

FIG. 1 is a diagram illustrating the hardware configuration of an image forming apparatus 1. The image forming apparatus 1 is an exemplary information processing apparatus according to the exemplary embodiment of the present invention. The image forming apparatus 1 includes a controller 11, a memory 12, a communication unit 13, a user interface (UI) unit 14, a reading unit 15, an image processor 16, and an image forming unit 17.

The controller 11 includes an arithmetic unit such as a central processing unit (CPU) and storage devices, such as a read only memory (ROM) and a random access memory (RAM), and exerts overall control, including display control described below, on the image forming apparatus 1. In the ROM, firmware which describes a procedure for activating hardware and an operating system (OS) is stored. The RAM is used as a storage of data used when the CPU performs calculation. The memory 12 includes, for example, a semiconductor memory and a hard disk storage device, and stores software (programs) for implementing various functions, as well as the OS. The communication unit 13 includes a communication interface (I/F) for communicating with external electronic equipment. The communication unit 13 is connected to a communication line such as a local area network (LAN).

The UI unit 14 includes a display and an operation unit. The display includes, for example, a liquid-crystal display device, and displays a screen through which a user operates the image forming apparatus 1, on a display surface. The operation unit includes a touch panel which, for example, covers the display surface of the display, and also includes a keyboard disposed adjacent to the display surface. The operation unit receives an operation performed by a user, and outputs, to the controller 11, a signal according to the operation. The controller 11 controls the image forming apparatus 1 according to information indicated by the operation.

The reading unit 15 optically reads a document and generates image data. The reading unit 15 is, for example, an image scanner including platen glass, a light source, an optical system, a color filter, and an image sensor. The light source emits light to a document on the platen glass, and reflected light from the document enters the image sensor through the optical system and the color filter. The image sensor converts the incident light into an image signal, and outputs the image signal to the image processor 16. The image processor 16 performs image processing, such as screen processing and color conversion, on the image signal which is output from the reading unit 15, and generates raster data. The image forming unit 17 forms an image based on the raster data generated by the image processor 16, on a sheet which is a recording medium. Examples of the image forming system include an electrophotographic system and an inkjet system.

FIG. 2 is a block diagram illustrating the functional configuration of the image forming apparatus 1. These functions are implemented by the controller 11 executing programs stored in the memory 12. A setting-information changing unit 110 changes setting information which is information for specifying a condition used when the function is implemented. In the case of a copy function, examples of the setting information include the number of copies, color/monochrome, and multiple-up (so-called N-up). When a derived function obtained by changing setting information of a certain function (original function) is to be stored in association with an icon selected by a user, a selecting unit 120 restricts selection of a first icon associated with the certain function, and permits selection of a second icon different from the first icon. When the derived function is to be stored in association with the second icon, a display controller 130 displays the first icon of a function corresponding to the original function for the derived function.

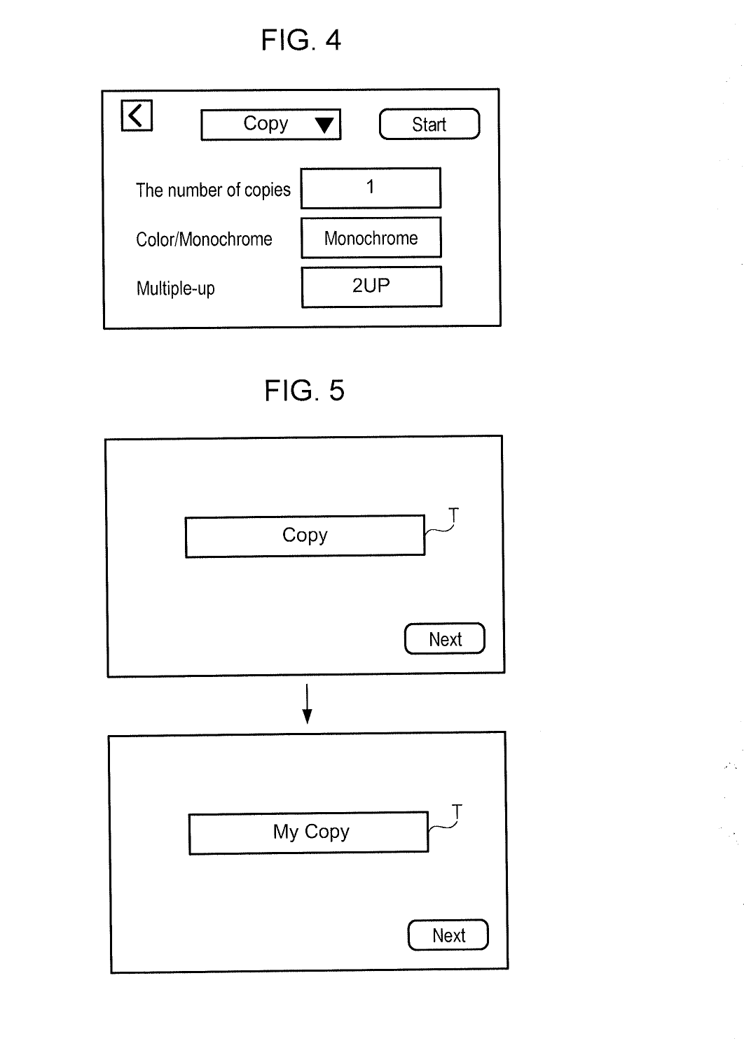

FIG. 3 is a diagram illustrating an initial screen displayed on the UI unit 14. The initial screen which is also called a home screen is a screen displayed first when the OS is activated. On the initial screen, icons associated with functions, such as a copy function, a facsimile function, and a scan function, are disposed. An icon is a virtual operator which is also called a shortcut or the like. When any icon is operated by a user, the function associated with the icon is activated, and a screen (see FIG. 4) for operating the function is displayed on the UI unit 14. A function which enters a state in which an operation is ready to be received, by being displayed on a screen is referred to as a function to be operated. That is, a function which is operating in the foreground is a function to be operated, and a function which is operating in the background is a function not to be operated.

In FIG. 3, for example, an icon Ic labeled “Copy” is an icon for specifying the copy function as a function to be operated. The copy function is a function of copying a document. When the icon Ic of the copy function is operated on the initial screen, the controller 11 displays a copy setting screen as illustrated in FIG. 4. The copy setting screen is a screen for operating the copy function. Specifically, various types of setting information, such as the number of copies to be made, color/monochrome, and multiple-up, may be registered or changed.

In these functions, the following operations may be performed: an operation of changing and storing setting information; an operation of storing a function obtained by changing setting information, as a new function; and an operation of resetting setting information which has been changed by a user, to the initial values. When setting information of a function is changed and stored, the function obtained after the setting information is changed corresponds to a derived function derived from the original function. A new function as which a function obtained by changing setting information is stored also corresponds to a derived function derived from the original function. Hereinafter, the former is called a functionally changed function, and the latter is called a newly registered function. When such a derived function is to be stored, not only the name of the function but also visual elements, such as the shape or pattern of the icon, the color of the icon, and the size of the icon, which are associated with the function may be changed. The change of visual elements of an icon which is described above causes a user to easily recognize a derived function obtained by changing setting information when the icon of a desired function is searched for on the initial screen.

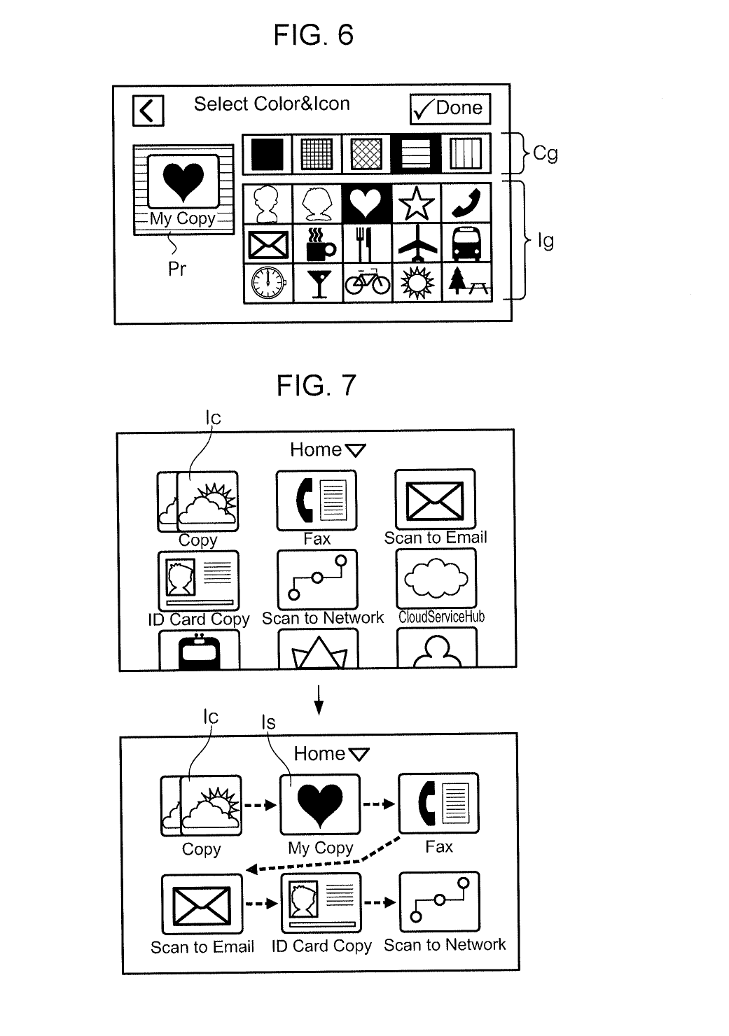

When a user performs a predetermined operation on a setting screen illustrated in FIG. 4, screens as illustrated in FIGS. 5 and 6 may be displayed, and a derived function may be stored. FIG. 5 illustrates exemplary screens for changing the name of a derived function. The name of the original function is first displayed in a text box T. When a user inputs the name of the derived function in the text box T, the name is displayed for the icon of the derived function. FIG. 5 illustrates an example in which a user changes the function name associated with an icon labeled “Copy”, to “My Copy” desired by the user. When the user performs a predetermined operation on the screen illustrated in FIG. 5, a screen illustrated in FIG. 6 is displayed, and visual elements of the icon may be changed.

FIG. 6 illustrates an exemplary screen for changing visual elements of an icon. On the screen, candidates Ig are displayed for the shape or pattern of the icon of the derived function, and candidates Cg are displayed for the color of the icon. When a user selects one of the candidates Ig for the shape or pattern of the icon, and selects one of the color candidates Cg, the shape or pattern, and the color of the icon are determined, and an icon having the icon shape or pattern and the color is displayed in a preview field Pr.

At that time, the icon Ic (first icon) of the copy function which is the original function for the derived function is not included in the candidates Ig. That is, an operation of selecting the icon of the copy function which is the original function, as the icon of the derived function for the copy function is restricted (prohibited). That is, selection is allowed to be performed on icons (second icons) that are different from the icon Ic (first icon) of the copy function which is the original function, and that are used as the candidates Ig. Similarly, the color of the icon Ic of the copy function which is the original function is not included in the candidates Cg. That is, an operation of selecting the color of the icon Ic of the copy function which is the original function, as the color of the icon of the derived function derived from the copy function is restricted (prohibited). That is, a color different from the color of the icon Ic of the copy function which is the original function is permitted to be selected. Thus, restriction imposed on the shape or pattern and the color of an icon facilitates visual recognition of the icon of a derived function obtained by changing setting information of the original function.

When a derived function is to be stored in association with an icon selected by a user as described above, while providing visual effects on the icon Ic (first icon) of the copy function which is the original function, the controller 11 makes a transition to display of the icon (second icon) of the derived function. Further, in the case of a newly registered function, the controller 11 displays the icon (second icon) of the derived function in a display area which has a predetermined positional relationship with the icon Ic (first icon) of the copy function which is the original function. In the case of a functionally changed function, the controller 11 does not move the icon Ic (first icon) of the copy function which is the original function, and changes the name and the visual elements of the icon Ic into those of the icon of the derived function.

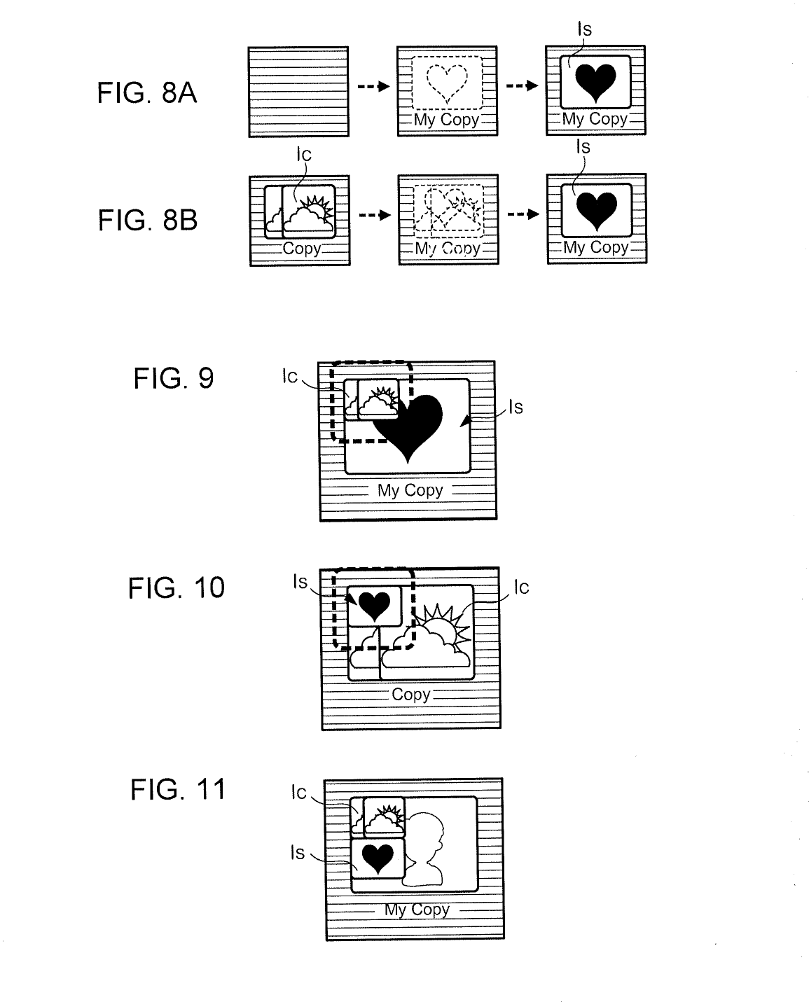

For example, when a derived function is newly registered for the copy function, as illustrated in FIG. 7, the controller 11 moves the position of each icon next to (in this example, adjacent to the right of) the “Copy” icon Ic to the position of the next icon (in FIG. 7, indicated by a dotted arrow), and obtains a space for one icon in a display area next to the “Copy” icon Ic. At that time, an icon (in the lower screen in FIG. 7, a “Scan to Email” icon) located on the right side in the same row as the “Copy” icon Ic is moved to the left side of one row below (in FIG. 7, indicated by a dotted arrow). Then, the position of each icon in the row is moved to that of the next icon (in FIG. 7, indicated by a dotted arrow). The controller 11 displays a “My Copy” icon Is which is newly registered, in the space thus obtained. At that time, as illustrated in FIG. 8A, the controller 11 provides visual effects on the background image of the obtained space in such a manner that the “My Copy” icon Is gradually appears. This causes a user to easily recognize where the icon is added.

In the case of a functionally changed function, as illustrated in FIG. 8B, the controller 11 provides visual effects in such a manner that the icon Ic of the original function “Copy” gradually disappears and that the “My Copy” icon Is of the derived function gradually appears. Thus, when a derived function is to be stored in association with an icon, display of the icon of the original function causes a user to easily recognize that the icon (first icon) of the original function is associated with the icon (second icon) of a derived function.

According to the exemplary embodiment, an icon associated with a function obtained by changing setting information may be displayed on a screen in such a manner as to be easy to visually recognize.

### Modified Embodiments

The exemplary embodiment may be changed as described below. Alternatively, multiple modified exemplary embodiments may be combined with one another.

<1>

The icon Is of a derived function may be common to the icon Ic of the original function only in part, but the entire icon Is may be different from the entire icon Ic. Specifically, as illustrated in FIG. 9, the icon Is of the derived function may be an icon in which a reduced icon Ic of the original function is superimposed on a heart icon selected by a user. As illustrated in FIG. 10, the icon Is of the derived function may be used in such a manner that an icon obtained by reducing the heart icon Is which is different from the icon Ic of the original function, and which is selected by a user is superimposed on the icon Ic of the original function. In either case, the icon Is of the derived function has an image portion common to that of the icon Ic of the original function. This facilitates visual recognition that setting information of the original function has been changed.

Alternatively, the shape or pattern of the icon Is of the derived function may be common to that of the icon Ic of the original function, and only the color of the icon Is may be different that of the icon Ic. This facilitates visual recognition that setting information of the original function has been changed.

<2>

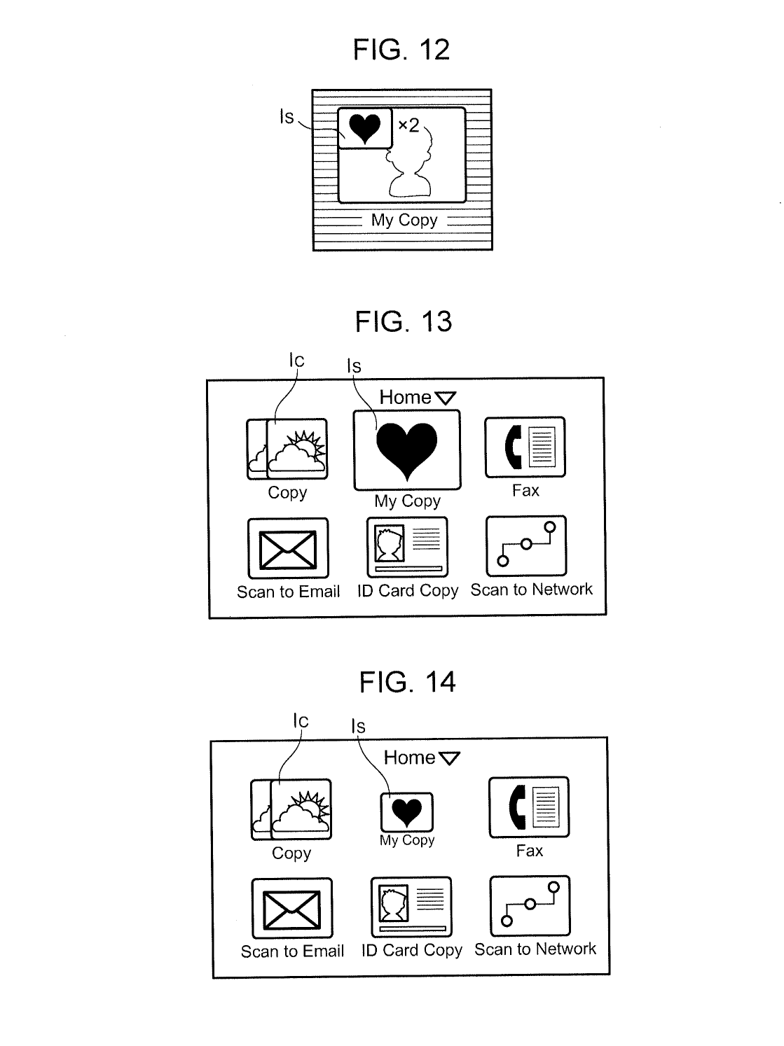

When a function obtained by changing setting information of a derived function is newly registered, the number of changes of setting information which have been made starting from the original function may be described on an icon. Specifically, as illustrated in FIG. 11, a reduced icon Ic of the original function and a reduced icon Is of the derived function for the original function may be superimposed on a man icon which has been newly registered, in such a manner that the reduced icon Ic and the reduced icon Is are vertically aligned. Alternatively, as illustrated in FIG. 12, an image in which the number of changes is described for the icon Is of the derived function may be superimposed on a man icon which has been newly registered. This facilitates visual recognition that how many times setting information has been changed starting from the original function.

<3>

The size of the original function icon may be different from that of the derived function icon. For example, as illustrated in FIGS. 13 and 14, the size of the icon Is of the derived function may be larger or smaller than that of the icon Ic of the original function. This facilitates visual recognition that setting information of the original function has been changed.

<4>

In the exemplary embodiment, when a derived function is to be stored in association with an icon, the icon of the original function is displayed by providing visual effects on the icon of the original function. Alternatively, for example, when a predetermined operation (for example, a touch operation performed during a period greater than a threshold, such as a so-called pressing and holding operation) is performed on the icon of the derived function, the controller 11 may cause the icon of the original function to be displayed.

<5>

When a derived function is to be stored in association with an icon, the controller 11 may restrict (prohibit) selection of an icon that has been already used for the original function or another different function.

<6>

In the above-described exemplary embodiment, the example in which the operation unit is provided with a touch panel function is described. However, the operation unit may be provided with a pointing device such as a mouse.

In the above-described exemplary embodiment, the example in which the above-described functions are implemented by the controller 11 executing programs is described. However, the above-described functions may be implemented by using a hardware circuit. In addition, the programs may be supplied by storing the programs in a computer-readable recording medium, such as an optical recording medium or a semiconductor memory. The programs may be read from the recording medium and may be installed in an information processing apparatus. Alternatively, the programs may be supplied through a telecommunication line.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a setting-information changing unit that changes setting information which is information for specifying a condition when a function is to be implemented; and
a selecting unit that, when a derived function is to be stored in association with a selected icon, the derived function being obtained by changing the setting information of the function, restricts selection of a first icon associated with the function, and permits selection of a second icon different from the first icon.

2. The information processing apparatus according to claim 1,
wherein the second icon is common to the first icon in part.

3. The information processing apparatus according to claim 2,
wherein the second icon is common to the first icon in shape or pattern, and is different from the first icon in color.

4. The information processing apparatus according to claim 2,
wherein the second icon has an image portion common to an image portion of the first icon.

5. The information processing apparatus according to claim 2,
wherein the second icon is an icon in which an image different from an image of the first icon is superimposed on the first icon.

6. The information processing apparatus according to claim 1, further comprising:
a display controller that, when the derived function is to be stored in association with the second icon, causes the first icon to be displayed.

7. The information processing apparatus according to claim 6,
wherein, when the derived function is to be stored in association with the second icon, the display controller makes a transition to display of the second icon while providing a visual effect on the first icon.

8. The information processing apparatus according to claim 6,
wherein, when a predetermined operation is performed on the second icon, the display controller causes the first icon to be displayed.

9. The information processing apparatus according to claim 1, further comprising:
a display controller that, when the derived function is to be stored in association with the second icon, causes the second icon to be displayed in a display area having a predetermined positional relationship with the first icon.

10. The information processing apparatus according to claim 1,
wherein, when the derived function is to be stored in association with the second icon, the selecting unit restricts selection of an icon that has been already used.

11. A non-transitory computer readable medium storing a program causing a computer to execute a process comprising:
changing setting information which is information for specifying a condition when a function is to be implemented; and
when a derived function is to be stored in association with a selected icon, the derived function being obtained by changing the setting information of the function, restricting selection of a first icon associated with the function, and permitting selection of a second icon different from the first icon.

12. An information processing method comprising:
changing setting information which is information for specifying a condition when a function is to be implemented; and
when a derived function is to be stored in association with a selected icon, the derived function being obtained by changing the setting information of the function, restricting selection of a first icon associated with the function, and permitting selection of a second icon different from the first icon.
